(19) United States
(12) Patent Application Publication
(10) Pub. No.: US 2026/0148054 A1
(43) Pub. Date: May 28, 2026

(54) THREE-DIMENSIONAL HETEROGENEOUS INTEGRATED OPTICAL COMPUTING CHIP

(71) Applicant: HUAZHONG UNIVERSITY OF SCIENCE AND TECHNOLOGY, Hubei (CN)

(72) Inventors: Jian WANG, Hubei (CN); Yuanjian Wan, Hubei (CN)

(73) Assignee: HUAZHONG UNIVERSITY OF SCIENCE AND TECHNOLOGY, Hubei (CN)

(21) Appl. No.: 19/186,506

(22) Filed: Apr. 22, 2025

(30) Foreign Application Priority Data
Nov. 28, 2024 (CN) 202411727737.3

(51) Int. Cl. G06N 3/067

(52) U.S. Cl. CPC G06N 3/067

(57) ABSTRACT

Provided is a three-dimensional (3D) heterogeneous integrated optical computing chip, which belongs to the field of optical computing. The computing chip is formed by three parts: a spatial diffraction optical neural network chiplet, a planar matrix reconfigurable optical neural network component, and a planar switchable optical switch module. Through a 3D heterogeneous integration method, one or more spatial diffraction optical neural network chiplets, the planar matrix reconfigurable optical neural network component, and the planar switchable optical switch module are combined together to achieve efficient multi-task optical computing processing. The disclosure utilizes the combination of the spatial diffraction optical neural network and the planar matrix reconfigurable optical neural network, breaking through the conventional optical computing architecture, which has broad application prospects in the field of optical computing and fills the gap in the relevant technical field.

### CROSS-REFERENCE TO RELATED APPLICATION

This application claims the priority benefit of China application serial no. 202411727737.3, filed on Nov. 28, 2024. The entirety of the above-mentioned patent application is hereby incorporated by reference herein and made a part of this specification.

### TECHNICAL FIELD

The disclosure belongs to the field of optical computing, more specifically, relates to a three-dimensional (3D) heterogeneous integrated optical computing chip.

### BACKGROUND

With the rapid development of artificial intelligence and deep learning, the demand for processing large-scale data and complex tasks has gradually increased. Conventional computing platforms such as CPU and GPU face performance bottlenecks and excessive energy consumption issues when dealing with these demands, which has prompted people to seek new computing methods to meet the growing computational requirements.

Optical computing, as an emerging computing method, may demonstrate significant advantages in processing large-scale data by leveraging the parallelism and high speed of optics. Compared to electronic computing, optical computing possesses superior characteristics such as high parallelism, low power consumption, interference resistance, and large-capacity transmission. Optical computing has broad application prospects in various fields, including artificial intelligence, image processing, data mining, and pattern recognition.

With the development of optical computing, the current mainstream optical neural networks include spatial diffraction neural networks and planar linear neural networks. Spatial diffraction neural networks utilize light diffraction between multi-phase planes to achieve multi-layer full connectivity for tasks such as image recognition. This network has a large number of neurons and can implement relatively large neural networks. However, after completing training, the network is unable to be freely adjusted, has a single function, and has certain limitations. Planar linear neural networks can be flexibly controlled to achieve different matrix configurations and operations, but the scale of operations is often limited by the network size.

### SUMMARY

For conventional optical neural network computing architectures, the disclosure provides a three-dimensional (3D) heterogeneous integrated optical computing chip, aiming to provide a novel optical neural network architecture to achieve efficient multi-task optical computing processing. A spatial diffraction optical neural network is utilized to perform feature extraction and dimensionality reduction on the input task, then processing and computation are performed through a planar matrix reconfigurable optical neural network component, and finally the computation result is output through detection by a detector array. By flexibly switching the planar matrix reconfigurable optical neural network component and different spatial diffraction optical neural network chiplets, multi-task flexible switching can be achieved. That is, the 3D heterogeneous integrated optical computing chip of the present disclosure combines spatial diffraction neural networks and planar linear matrix networks through 3D heterogeneous integration method to achieve efficient multi-task optical computing processing.

To achieve the above-mentioned purpose, the disclosure provides a 3D heterogeneous integrated optical computing chip, including a spatial diffraction optical neural network chiplet, a planar matrix reconfigurable optical neural network component, and a planar switchable optical switch module. The spatial diffraction optical neural network chiplet, the planar matrix reconfigurable optical neural network component, and the planar switchable optical switch module are integrated through a 3D heterogeneous integration method. The spatial diffraction optical neural network chiplet includes no less than 1 layer of multi-phase plane, with propagation layers between the multi-phase planes. The planar matrix reconfigurable optical neural network component includes a linear matrix network module and a detector array connected in sequence.

The spatial diffraction neural network chiplet is used to perform feature extraction and dimensionality reduction on the task to be processed, so as to obtain a feature output result. The feature output result may be input to the planar switchable optical switch module for state configuration through a coupling manner. The planar matrix reconfigurable optical neural network component may be used to perform operations on the feature output result after state configuration.

Beneficial effects: Through heterogeneous integration method, the combination of single or multiple spatial diffraction optical neural network chiplets, the planar matrix reconfigurable optical neural network component, and the planar switchable optical switch module are realized, thereby the disclosure achieves efficient multi-task optical computing processing. During the computation process of the optical computing chip, the task to be processed is input into the spatial diffraction optical neural network chiplet for feature extraction and dimensionality reduction, subsequently, input into the planar switchable optical switch module for state configuration through coupling; finally, the task is input into the planar matrix reconfigurable optical neural network component for computational processing, and the computation result is detected and output through the detector array integrated on the planar matrix reconfigurable optical neural network component. In the optical computing process, nonlinear activation functions may be inserted to implement nonlinear operations, thereby improving the accuracy of task identification. For dataset tasks with similar features, the operation may be realized by reconfiguring the matrix parameters of the planar matrix reconfigurable optical neural network component; for dataset tasks with significantly different features, the operation may be realized by adjusting the configuration state of the planar switchable optical switch module and the matrix configuration of the planar matrix reconfigurable optical neural network component; simultaneously, combined with feedback control and intelligent algorithms, driven by tasks, adaptive adjustment of the planar switchable optical switch module and the planar matrix reconfigurable optical neural network component may be performed to achieve efficient and intelligent self-learning and self-configuring multi-task identification.

Preferably, the spatial diffraction optical neural network chiplet is based on spatial diffraction optical principles. Through the optimized design of multi-phase planes, combined with the unique structure of the spatial diffraction optical neural network, the pixel points of the multi-phase planes serve as neurons, with approximately full connections established between layers through optical diffraction, thereby realizing linear operations. By utilizing the diffraction characteristics of light waves during propagation, and through adjusting the distribution of phase planes, the propagation and superposition of the light field is precisely controlled, thus achieving dimensionality reduction and feature extraction of high-pixel image information.

Preferably, the spatial diffraction optical neural network chiplet is formed by stacking multi-phase planes through a 3D integration method to form the spatial diffraction optical neural network chiplet, with no less than 1 layer, and propagation layers formed by low refractive index material exist between the layers. The 3D integration process may be implemented through technologies such as transfer printing, direct bonding, or femtosecond laser 3D direct writing, to integrate multi-phase planes into the spatial diffraction optical neural network chiplet. The phase planes may be implemented based on principles such as resonant phase, transmission phase, or geometric phase, and the constituent units of each phase plane may be metasurface units or diffraction optical units.

Preferably, the planar matrix reconfigurable optical neural network component is formed by a linear matrix network module and a detector array. The linear matrix network module is used to implement arbitrary reconfigurable optical matrix calculations, linearly process the signals output by the planar switchable optical switch module, and then output the computation result through the detector array.

Preferably, the linear matrix network includes a network formed by Mach-Zehnder interferometers, microring arrays, or multimode interference waveguides. Arbitrary linear optical matrix configurations may be achieved through control of reconfigurable units on the linear matrix network module to adapt to the requirements of different tasks.

Preferably, the planar switchable optical switch module includes a high-efficiency coupler array and a switchable optical switch. The high-efficiency coupler array is used to receive feature output results from different spatial diffraction optical neural network chiplets, and convert spatial light modes into waveguide modes; the switchable optical switch is used to implement the working state configuration of the planar switchable optical switch module, selectively outputting feature output results from different spatial diffraction optical neural network chiplets to the planar matrix reconfigurable optical neural network component.

Preferably, the processing materials for the spatial diffraction optical neural network chiplet include, for example, silicon, silicon nitride, metal, silicon dioxide, and polymer; the processing materials for the planar matrix reconfigurable optical neural network component and the planar switchable optical switch module include silicon, germanium, silicon dioxide, indium phosphide, gallium arsenide, thin-film lithium niobate, polymer, or phase change material, or a mixture of the above materials.

Preferably, the nonlinear activation function may be realized by inserting materials with nonlinear response (such as graphene, phase change materials, and reverse saturable absorber materials) between layers of the spatial diffraction optical neural network chiplet; the nonlinear activation function in the planar matrix reconfigurable optical neural network component may be formed by, for example, microring, a germanium-silicon material, and an SOA material; or after completing the optical operation, the output result may be subjected to nonlinear activation function operation in the electrical domain, thereby improving the identification accuracy.

Preferably, the 3D heterogeneous integration method is through multi-chiplet integration, directly bonding the spatial diffraction optical neural network chiplet onto a planar chip formed by the planar matrix reconfigurable optical neural network component and the planar switchable optical switch module; alternatively, different spatial diffraction optical neural network chiplets, the planar matrix reconfigurable optical neural network component, and the planar switchable optical switch module may be bonded to specific areas of an optical interposer, and connection among the spatial diffraction optical neural network chiplets, the planar matrix reconfigurable optical neural network component, and the planar switchable optical switch module is realized through the optical interposer.

Preferably, the task configuration method for the 3D heterogeneous integrated optical computing chip dynamically switches the routing connections between different spatial diffraction optical neural network chiplets and the planar matrix reconfigurable optical neural network component through the planar switchable optical switch module according to task types, ensuring the flexibility and efficiency of the task processing path. Simultaneously, by dynamically adjusting the matrix weight configuration of the planar matrix reconfigurable optical neural network component, computational requirements of different tasks are adapted, and efficient and precise feature extraction and result output can be achieved. Further, this method may further combine feedback control and intelligent algorithms to adaptively optimize and adjust the routing state of the planar switchable optical switch module and the matrix parameters of the planar matrix reconfigurable optical neural network component, realizing task-driven self-learning and self-configuring multi-task configuration, thereby improving efficiency and intelligence level in switching and identifying different tasks. This configuration method not only meets the rapid identification of tasks with similar features, but also achieves precise processing of differentiated tasks through deep optimization, and provides self-driving, self-learning, and self-configuring capabilities, ultimately realizing efficient intelligent recognition and computation in multi-task scenarios.

Compared with the existing technology, the technical solution conceived by this disclosure has the following beneficial effects:
1. The disclosure discloses a 3D heterogeneous integrated optical computing chip, which fully utilizes the advantages of spatial diffraction neural network and planar matrix neural network to perform efficient multi-task parallel computing. Compared to the serial computing method of electronic computers, a new approach for improving computational power is provided.
2. The disclosure utilizes the strong processing capability of the spatial diffraction optical neural network chiplet to perform dimensionality reduction processing on the input task, achieving feature extraction and reducing the processing difficulty of the planar matrix reconfigurable optical neural network component, which realizes efficient computational processing.
3. The disclosure utilizes the flexibility of the planar matrix reconfigurable optical neural network component to flexibly configure for the input task, performing linear operations on the features extracted by the spatial diffraction optical neural network chiplet, which can achieve configuration for different tasks.
4. The disclosure utilizes the flexibility of a multi-chiplet approach to flexibly configure for tasks with significant differences. Different spatial diffraction optical neural network chiplets are connected to the planar matrix reconfigurable optical neural network component to process different data tasks.
5. The computing architecture concept of the disclosure has universal applicability and may also be applied to other neural network information processing.

### BRIEF DESCRIPTION OF THE DRAWINGS

FIG. 1 shows an architecture of a three-dimensional (3D) heterogeneous integrated optical computing chip.

FIG. 2 shows a working unit of a spatial diffraction optical neural network chiplet.

FIG. 3 is a working principle diagram of the spatial diffraction optical neural network chiplet.

FIG. 4 is a schematic diagram of a planar switchable optical switch module.

FIG. 5 is a schematic diagram of a planar matrix reconfigurable optical neural network component.

FIG. 6 is a working principle diagram of the planar matrix reconfigurable optical neural network component.

FIG. 7 is a schematic diagram of a planar chip.

FIG. 8 is a schematic diagram of the 3D heterogeneous integrated optical computing chip.

FIG. 9 is a schematic diagram of the working of a 3D heterogeneous integrated optical computing chip system.

### DESCRIPTION OF THE EMBODIMENTS

In order to make the purpose, technical solution, and advantages of the disclosure clearer, the following description will provide further detailed explanation of the disclosure in combination with the drawings and embodiments. It should be understood that the specific embodiments described herein are merely used to explain the disclosure and are not intended to limit the disclosure. In addition, the technical features involved in the various embodiments of the disclosure described below may be combined with each other as long as the technical features do not conflict with each other.

The disclosure provides a three-dimensional (3D) heterogeneous integrated optical computing chip, and the optical computing chip is formed by three parts: a spatial diffraction optical neural network chiplet, a planar matrix reconfigurable optical neural network component, and a planar switchable optical switch module. Through heterogeneous integration method, the combination of single or multiple spatial diffraction optical neural network chiplets, the planar matrix reconfigurable optical neural network component, and the planar switchable optical switch module are realized, thereby achieving efficient multi-task optical computing processing. During the computation process of the optical computing chip, the task to be processed is input into the spatial diffraction optical neural network chiplet for feature extraction and dimensionality reduction, subsequently, input into the planar switchable optical switch module for state configuration through coupling; finally, the task is input into the planar matrix reconfigurable optical neural network component for computational processing, and the computation result is detected and output through the detector array integrated on the planar matrix reconfigurable optical neural network component. In the optical computing process, nonlinear activation functions may be inserted to implement nonlinear operations, thereby improving the accuracy of task identification. For dataset tasks with similar features, the operation may be realized by reconfiguring the matrix parameters of the planar matrix reconfigurable optical neural network component; for dataset tasks with significantly different features, the operation may be realized by adjusting the configuration state of the planar switchable optical switch module and the matrix configuration of the planar matrix reconfigurable optical neural network component; simultaneously, combined with feedback control and intelligent algorithms, driven by tasks, adaptive adjustment of the planar switchable optical switch module and the planar matrix reconfigurable optical neural network component may be performed to achieve efficient and intelligent self-learning and self-configuring multi-task identification.

Specifically, the spatial diffraction optical neural network chiplet is based on spatial diffraction optical principles. Through the optimized design of multi-phase planes, combined with the unique structure of the spatial diffraction optical neural network, the pixel points of the multi-phase planes serve as neurons. The near-full connectivity between layers is established through optical diffraction, thereby realizing large-scale linear operations. By utilizing the diffraction characteristics of light waves during propagation and adjusting the distribution of phase planes, the propagation and superposition of the light field may be precisely controlled, thus achieving dimensionality reduction and feature extraction of high-pixel image information.

Specifically, the spatial diffraction optical neural network chiplet may be formed by stacking multi-phase planes through a 3D integration method to form the spatial diffraction optical neural network chiplet, with no less than 1 layer, and propagation layers formed by low refractive index material exist between the layers. The 3D integration process may be implemented through technologies such as transfer printing, direct bonding, or femtosecond laser 3D direct writing, to integrate multi-phase planes into the spatial diffraction optical neural network chiplet. The phase planes may be implemented based on principles such as resonant phase, transmission phase, or geometric phase, and the constituent units of each phase plane may be metasurface units or diffraction optical units.

Specifically, the planar matrix reconfigurable optical neural network component is formed by a linear matrix network module and a detector array. The linear matrix network module is used to implement arbitrary reconfigurable optical matrix calculations, linearly process the signals output by the planar switchable optical switch module, and then output the computation result through the detector array.

Specifically, the linear matrix network includes a network formed by Mach-Zehnder interferometers, microring arrays, or multimode interference waveguides. Arbitrary linear optical matrix configurations may be achieved through control of reconfigurable units on the linear matrix network module to adapt to the requirements of different tasks.

Specifically, the planar switchable optical switch module includes a high-efficiency coupler array and a switchable optical switch. The high-efficiency coupler array is used to receive feature output results from different spatial diffraction optical neural network chiplets, and convert spatial light modes into waveguide modes; the switchable optical switch is used to implement the working state configuration of the planar switchable optical switch module, selectively outputting feature output results from different spatial diffraction optical neural network chiplets to the planar matrix reconfigurable optical neural network component.

Specifically, the processing materials for the spatial diffraction optical neural network chiplet include, for example, silicon, silicon nitride, metal, silicon dioxide, and polymer; the processing materials for the planar matrix reconfigurable optical neural network component and the planar switchable optical switch module include silicon, germanium, silicon dioxide, indium phosphide, gallium arsenide, thin-film lithium niobate, polymer or phase change material, or a mixture of the above materials.

Specifically, the nonlinear activation function may be realized by inserting materials with nonlinear response (such as graphene, phase change materials, and reverse saturable absorber materials) between layers of the spatial diffraction optical neural network chiplet; the nonlinear activation function in the planar matrix reconfigurable optical neural network component may be formed by, for example, microring, germanium-silicon material, SOA material; or after completing the optical operation, the output result may be subjected to nonlinear activation function operation in the electrical domain, thereby improving the identification accuracy.

Specifically, the 3D heterogeneous integration method may be implemented through multi-chiplet integration, by directly bonding the spatial diffraction optical neural network chiplet onto a planar chip formed by the planar matrix reconfigurable optical neural network component and the planar switchable optical switch module; alternatively, different spatial diffraction optical neural network chiplets, the planar matrix reconfigurable optical neural network component, and the planar switchable optical switch module may be bonded to specific areas of an optical interposer, and the connection between the spatial diffraction optical neural network chiplet and the planar matrix reconfigurable optical neural network component and planar switchable optical switch module may be realized through the optical interposer.

Specifically, the task configuration method for the 3D heterogeneous integrated optical computing chip may dynamically switch the routing connections between different spatial diffraction optical neural network chiplets and the planar matrix reconfigurable optical neural network component through the planar switchable optical switch module according to the task type, ensuring the flexibility and efficiency of the task processing path. Meanwhile, by dynamically adjusting the matrix weight configuration of the planar matrix reconfigurable optical neural network component to adapt to the computational requirements of different tasks, efficient and precise feature extraction and result output can be achieved. In addition, this method may further combine feedback control and intelligent algorithms to adaptively optimize and adjust the routing state of the planar switchable optical switch module and the matrix parameters of the planar matrix reconfigurable optical neural network component, realizing task-driven self-learning and self-configuring multi-task configuration, thereby improving efficiency and intelligence level in switching and identifying different tasks. This configuration method not only meets the rapid identification of tasks with similar features, but also achieves precise processing of differentiated tasks through deep optimization, and provides self-driving, self-learning, and self-configuring capabilities, ultimately realizing efficient intelligent recognition and computation in multi-task scenarios.

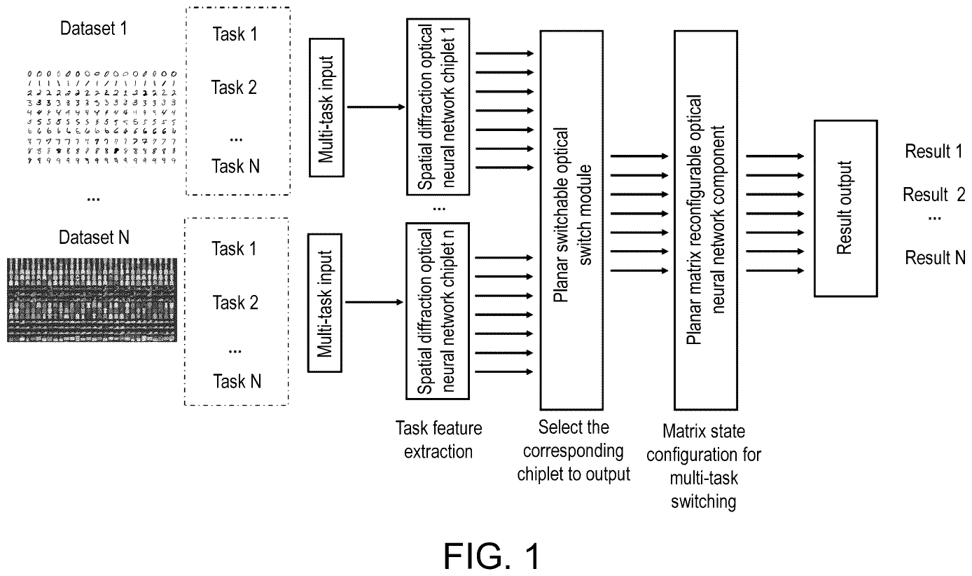

As shown in FIG. 1, the disclosure provides an architecture of the 3D heterogeneous integrated optical computing chip. The chip includes two core modules: different (multiple) spatial diffraction optical neural network chiplets, the planar switchable optical switch module, and the planar matrix reconfigurable optical neural network component. That is, the different spatial diffraction optical neural network chiplets corresponds to different datasets respectively, as shown in FIG. 1. Through the 3D heterogeneous integration method, the efficient feature extraction capability of the spatial diffraction optical neural network is combined with the flexible linear operation capability of the planar matrix reconfigurable optical neural network to achieve efficient, multi-task optical computing processing.

Specific working principle:

### 1. Input Processing:

When tasks from different datasets are input, the corresponding spatial diffraction optical neural network chiplet is selected through an external control circuit. Task inputs are usually transmitted in the form of optical images, and the initial light field distribution is generated through modulation.

### 2. Feature Extraction and Dimensionality Reduction of the Spatial Diffraction Optical Neural Network:

The spatial diffraction optical neural network chiplet is formed by stacking multi-phase planes, with the phase plane of each layer optimized and trained through prior simulation computations. The trained phase planes may realize feature extraction and dimensionality reduction operations on input data according to task characteristics. The phase planes modulate the wavefront information of the input light field, thereby extracting task-related key features. Through the cascading effect of multi-phase planes, high-dimensional input data is projected into a low-dimensional feature space for subsequent efficient computation.

### 3. State Configuration of the Planar Switchable Optical Switch Module:

The optical signals (that is, task features) output from the spatial diffraction optical neural network enter the planar switchable optical switch module through a highly efficient coupler array. The planar switchable optical switch selects the appropriate routing for the current spatial diffraction optical neural network chiplet according to the external control, ensuring that the task features are correctly transmitted to the corresponding matrix network module.

### 4. Matrix Operation of the Planar Matrix Reconfigurable Optical Neural Network Component:

For different datasets and tasks, the external control circuit is responsible for the working state of the planar matrix reconfigurable optical neural network. Through the control circuit, the weight configuration of the linear matrix network module is adjusted, thereby achieving efficient support for multi-task operations.

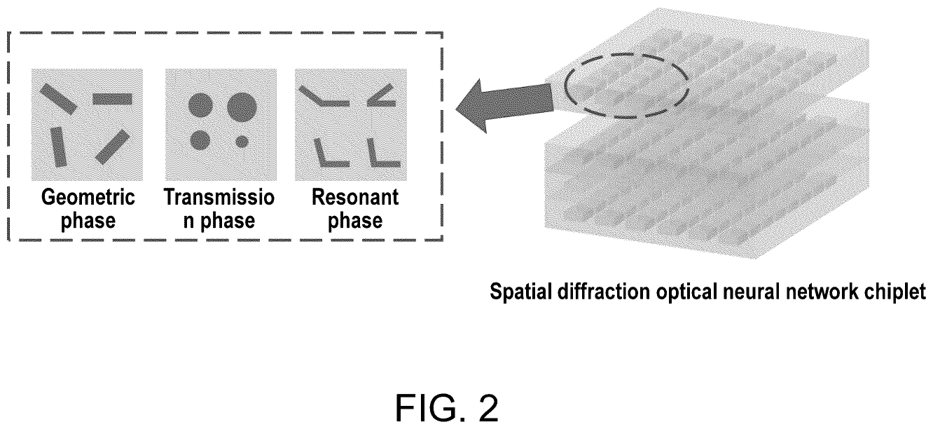

As shown in FIG. 2, the spatial diffraction optical neural network chiplet is formed by stacking multi-phase planes through a 3D integration method, with propagation layers formed by low refractive index materials existing between the layers. The phase planes may be implemented based on principles such as geometric phase, transmission phase, or resonant phase.

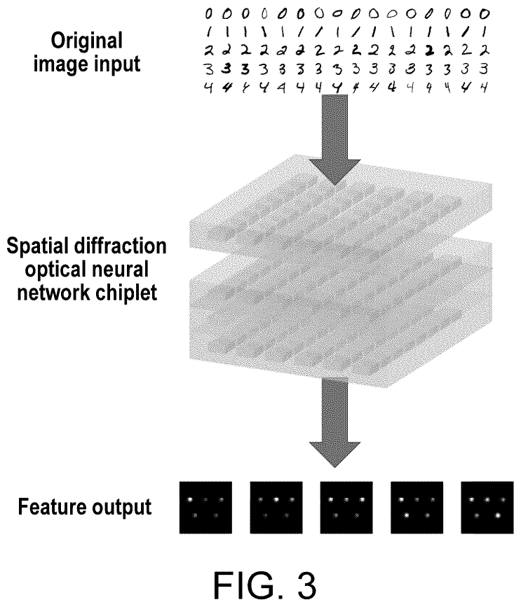

As shown in FIG. 3, the working principle of the spatial diffraction optical neural network chiplet is based on the spatial diffraction principle. Through the optimized design of multi-phase planes, combined with the unique structure of the spatial diffraction optical neural network, large-scale linear operations are achieved. By utilizing the diffraction characteristics of light waves during propagation, and through adjusting the distribution of phase planes, the propagation and superposition of the light field is precisely controlled, thus achieving dimensionality reduction and feature extraction of high-pixel image information. As illustrated in the drawing, the digital image in the drawing is subjected to dimensionality reduction and feature extraction, and turned into a combination of several light spots, which are provided to the subsequent planar chip for processing.

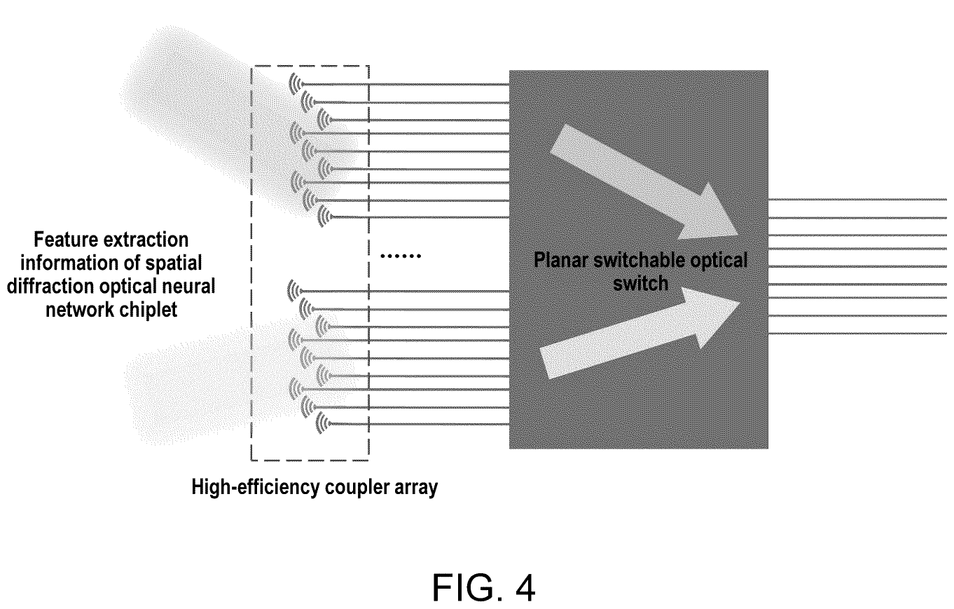

As shown in FIG. 4, the planar switchable optical switch module is formed by a high-efficiency coupler array and the switchable optical switch. The high-efficiency coupler array is used to receive feature output results from different spatial diffraction optical neural network chiplets, and convert spatial light modes into waveguide modes through an array of grating couplers, realizing signal conversion from space to plane. The switchable optical switch is used to realize the working state configuration of the planar switchable optical switch module, selectively outputting feature output results from different spatial diffraction optical neural network chiplets to the planar matrix reconfigurable optical neural network component, as shown by the different colored signals in the drawing, for selective output.

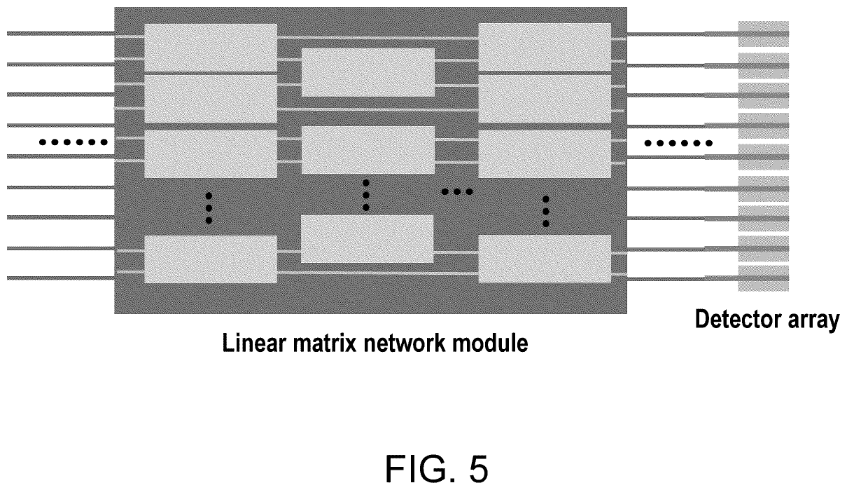

As shown in FIG. 5, a schematic diagram of the planar matrix reconfigurable optical neural network component, the planar matrix reconfigurable optical neural network component is formed by a linear matrix network module and a detector array. The linear matrix network module is used to implement arbitrary reconfigurable optical matrix calculations, may be formed by a network formed by Mach-Zehnder interferometers, microring arrays, or multimode interference waveguides, linearly processes the signals output by the planar switchable optical switch module, and then outputs the computation result through the detector array.

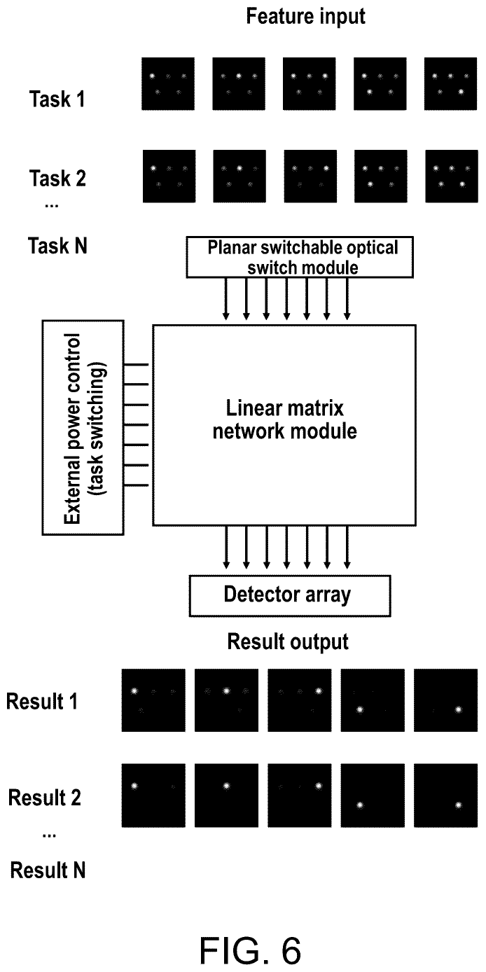

As shown in FIG. 6 is the working principle of the planar matrix reconfigurable optical neural network component. The following is a detailed explanation of the working principle thereof: the features extracted by the spatial diffraction optical neural network chiplet are shown as the task input in FIG. 6. Through the spatial diffraction optical neural network chiplet, complex image processing can be dimensionally reduced to different light spots, which are selectively input to the planar matrix reconfigurable optical neural network component in the form of optical signals through the planar switchable optical switch module. The external power supply is connected to the reconfigurable units of the on-chip network through the electrical control interface, which may dynamically adjust the working parameters (such as phase modulation) of various modules in the linear matrix network. According to the characteristics of the input task, the linear matrix network may configure different matrix weights in real-time, adapting to different task requirements, and thereby multi-task flexible switching is achieved. After the input features are processed by the linear matrix network, as shown in the result output in FIG. 6, it may be clearly seen that the originally chaotic signals may be linearly processed to achieve task identification result output. The identification effect is notable, with signals from different images converging at different locations. The optical signals enter the detector array for optical-to-electrical conversion, outputting the corresponding task identification results.

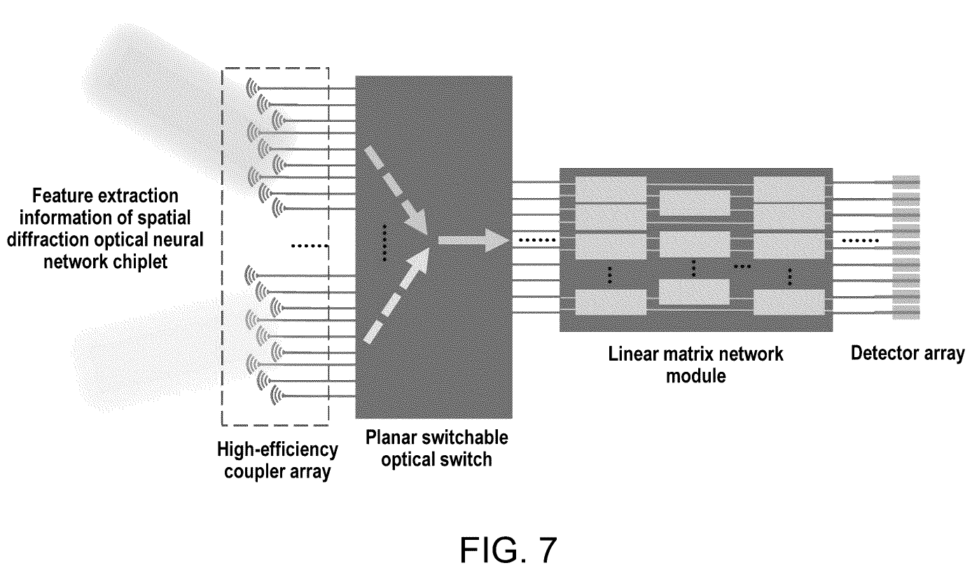

As shown in FIG. 7, the planar chip integrates and connects the planar switchable optical switch module with the planar matrix reconfigurable optical neural network component.

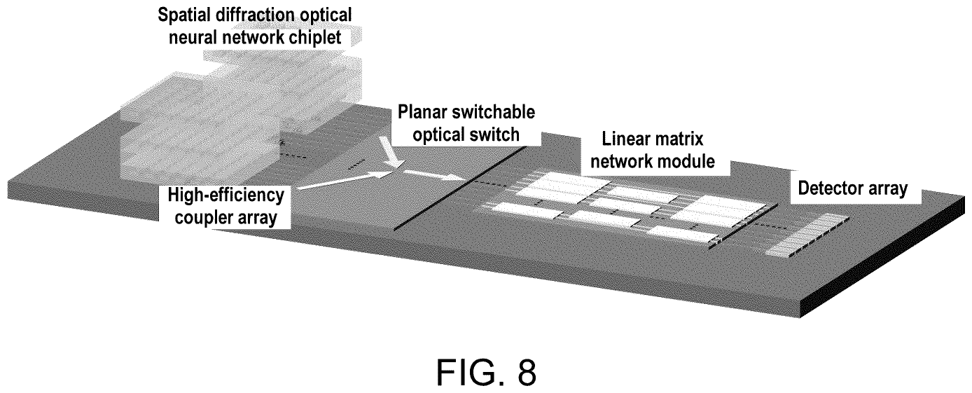

As shown in FIG. 8, the 3D heterogeneous integrated optical computing chip integrates the spatial diffraction optical neural network chiplets with the planar chip through 3D heterogeneous integration. The multiple spatial diffraction optical neural network chiplets are integrated with the planar chip onto the corresponding high-efficiency coupler array, making the components correspond one-to-one.

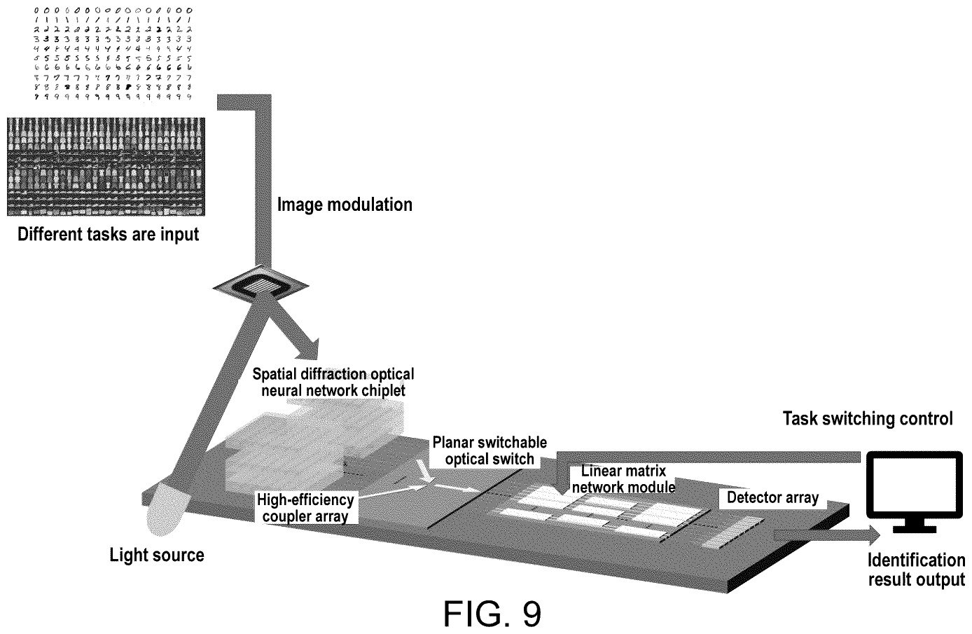

As shown in FIG. 9 is a schematic diagram of the working of a 3D heterogeneous integrated optical computing chip system. The following is a detailed explanation of the working principle thereof:

### 1. Data Input

Input data type: Input data such as handwritten digit images (for example, MNIST dataset) are converted into optical signals through an external devices (such as light sources or image projection devices). The input optical signals undergo preliminary modulation and encoding to adapt to the computational requirements of the subsequent spatial diffraction optical neural network.

### 2. Feature Extraction of the Spatial Diffraction Optical Neural Network Chiplet

The input optical signal is transmitted to the spatial diffraction optical neural network chiplet, and the chiplet is formed by multi-phase planes. Through the action of these phase planes, feature extraction and dimensionality reduction processing are performed on the input signal. Different task datasets correspond to different chiplets, and the phase design of each chiplet is optimized and trained to ensure that key features related to the task are extracted.

### 3. State Configuration of the Planar Switchable Optical Switch Module:

The optical signals (that is, task features) output from the spatial diffraction optical neural network enter the planar switchable optical switch module through a highly efficient coupler array. The planar switchable optical switch selects the appropriate routing for the current spatial diffraction optical neural network chiplet according to the external control, ensuring that the task features are correctly transmitted to the corresponding matrix network module.

### 4. Task Identification of the Planar Matrix Reconfigurable Optical Neural Network Component:

The planar matrix reconfigurable optical neural network component performs linear operations on input feature signals through a dynamically configured linear matrix network. The system intelligently controls the planar switchable optical switch module and the planar matrix reconfigurable optical neural network component through the external circuit, dynamically selecting network configurations adapted to the current task, thereby achieving flexibility in multi-task processing.

### 5. Task Output

The operation result is output by the planar matrix reconfigurable optical neural network component and enter the detector array for optical-to-electrical signal conversion. The converted electrical signal, as the task processing result, is output to external devices for further processing or direct display.

Persons skilled in the art may easily understand that the above description are merely preferred embodiments of the disclosure and the embodiments are not intended to limit the disclosure. Any modifications, equivalent substitutions, and improvements made within the spirit and principle of the disclosure should be included in the protection scope of the disclosure.

What is claimed is:

1. A three-dimensional (3D) heterogeneous integrated optical computing chip, comprising a spatial diffraction optical neural network chiplet, a planar matrix reconfigurable optical neural network component, and a planar switchable optical switch module, the spatial diffraction optical neural network chiplet, the planar matrix reconfigurable optical neural network component, and the planar switchable optical switch module are integrated through a 3D heterogeneous integration method, the spatial diffraction optical neural network chiplet comprises no less than 1 layer of multi-phase plane with propagation layers between the multi-phase plane, the planar matrix reconfigurable optical neural network component comprises a linear matrix network module and a detector array connected in sequence,
the spatial diffraction optical neural network chiplet is configured to perform feature extraction and dimensionality reduction on a task to be processed so as to obtain a feature output result, the feature output result is input to the planar switchable optical switch module for state configuration through a coupling manner, and the planar matrix reconfigurable optical neural network component is configured to perform operations on the feature output result after state configuration.

2. The 3D heterogeneous integrated optical computing chip according to claim 1, wherein pixel points of the multi-phase plane serve as neurons, with approximately full connections established between layers through optical diffraction, thereby realizing linear operations.

3. The 3D heterogeneous integrated optical computing chip according to claim 1, wherein the 3D heterogeneous integration method comprises transfer printing, direct bonding, or femtosecond laser 3D direct writing.

4. The 3D heterogeneous integrated optical computing chip according to claim 2, wherein the multi-phase plane is a metasurface unit or a diffraction optical unit.

5. The 3D heterogeneous integrated optical computing chip according to claim 1, wherein the linear matrix network module comprises a Mach-Zehnder interferometer, a microring array, or a multimode interference waveguide.

6. The 3D heterogeneous integrated optical computing chip according to claim 1, wherein the planar switchable optical switch module comprises a coupler array and an optical switch, the coupler array is configured to receive feature optical signals from different spatial diffraction optical neural network chiplets and convert spatial light modes to waveguide modes, and the optical switch is configured to implement a working state configuration of the planar switchable optical switch module and selectively output feature output results from the different spatial diffraction optical neural network chiplets to the planar matrix reconfigurable optical neural network component.

7. The 3D heterogeneous integrated optical computing chip according to claim 1, wherein a processing material of the spatial diffraction optical neural network chiplet comprises silicon, silicon nitride, metal, silicon dioxide, and polymer, and a processing material of the planar matrix reconfigurable optical neural network component and the planar switchable optical switch module comprises silicon, germanium, silicon dioxide, indium phosphide, gallium arsenide, thin film lithium niobate, polymer, phase change material, or a mixture of the above materials.

8. The 3D heterogeneous integrated optical computing chip according to claim 1, wherein the spatial diffraction optical neural network chiplet further comprises a first nonlinear activation function layer, the first nonlinear activation function layer is between layers of the multi-phase plane, the first nonlinear activation function layer is configured to implement nonlinear operation, a material of the nonlinear activation function layer is graphene, phase change material, or reverse saturable absorber materials, the planar matrix reconfigurable optical neural network component further comprises a second nonlinear activation function layer, the second nonlinear activation function layer is between the matrix network module and the detector array, and a material of the second nonlinear activation function layer is a germanium-silicon material or an SOA material.

9. The 3D heterogeneous integrated optical computing chip according to claim 3, wherein the 3D heterogeneous integration method is through multi-chiplet integration, directly bonding the spatial diffraction optical neural network chiplet onto a planar chip formed by the planar matrix reconfigurable optical neural network component and the planar switchable optical switch module; alternatively, the different spatial diffraction optical neural network chiplets, the planar matrix reconfigurable optical neural network component, and the planar switchable optical switch module are bonded to preset areas of an optical interposer, and connection among the spatial diffraction optical neural network chiplets, the planar matrix reconfigurable optical neural network component, and the planar switchable optical switch module is realized through the optical interposer.

10. The 3D heterogeneous integrated optical computing chip according to claim 1, wherein the planar switchable optical switch module dynamically switches routing connections between different spatial diffraction optical neural network chiplets and the planar matrix reconfigurable optical neural network component according to task types; simultaneously, a matrix weight configuration of the planar matrix reconfigurable optical neural network component is dynamically adjusted to adapt to computational requirements of different tasks; further, comprising combining feedback control and intelligent algorithms to adaptively optimize and adjust a routing state of the planar switchable optical switch module and matrix parameters of the planar matrix reconfigurable optical neural network component, task-driven self-learning and self-configuring multi-task configuration are realized.
